(19) United States
(12) Patent Application Publication
(10) Pub. No.: US 2020/0071075 A1
(43) Pub. Date: Mar. 5, 2020

(54) Fully Automated Autonomous Self Storage System

(71) Applicant: Chang Yup Lee, Los Angeles, CA (US)

(72) Inventor: Chang Yup Lee, Los Angeles, CA (US)

(21) Appl. No.: 16/392,399

(22) Filed: Apr. 23, 2019

Related U.S. Application Data
(60) Provisional application No. 62/725,251, filed on Aug. 30, 2018.

(51) Int. Cl. B65G 1/137; B65G 1/04

(52) U.S. Cl. CPC B65G 1/1371; G05B 2219/50391; B65G 1/0485

(57) ABSTRACT

A storage system includes storage modules, which are stored in a three-dimensional array, transportation devices that transport the storage modules, a control device that controls movements of and access to the storage modules and a storage structure that includes storage spaces for storing the storage modules, and transportation tracks for the transportation devices. The storage spaces comprise the three-dimensional array. The transportation device includes a horizontal linear movement device, a horizontal rotational movement device and a vertical linear movement device. The horizontal rotational movement device rotates the storage module during when the horizontal linear movement device moves the storage module.

### CROSS-REFERENCE TO RELATED APPLICATION(S)

This application claims priority on the inventor's Provisional Application No. 62/725,251 filed on 30 Aug. 2018, the disclosure of which is incorporated by reference as if fully set forth herein. This application is related to the inventor's patent application Ser. No. 15/655,862 filed on Jul. 20, 2017 and patent application Ser. No. 15/713,528 filed on Sep. 22, 2017, the disclosure of which are incorporated by reference as if fully set forth herein.

### BACKGROUND OF THE INVENTION

### 1. Field of the Invention

The present invention is related to a fully automated autonomous rack and rail self storage system.

### 2. Discussion of Related Technology

In a typical conventional self storage facility, access to each storage cells are necessary and thus require significant portion of the building footprint is dedicated for the corridors and the access passage ways large enough to accommodate maneuverability of dollies and large cart turns. There have been attempts in the past via several inventions to achieve the maximum building efficiency and the system operational efficiency by utilizing means of automated system including vertical rotary system, robotic stacker system and horizontal conveyor systems. The foregoing discussion in this section is to provide general background information, and does not constitute an admission of prior art.

### SUMMARY OF THE INVENTION

An objective of the invention is to provide an automated storage system that utilizes the automatic functions of a parking structure.

In order to achieve the objective, the present invention provides a storage system comprising a plurality of storage modules, which are stored in a three-dimensional array; one or more transportation devices that transport the storage modules; a control device that controls movements of and access to the storage modules; and a storage structure that comprises storage spaces for storing the storage modules, and transportation tracks for the transportation devices. The storage spaces comprise the three-dimensional array. The transportation device comprises a horizontal linear movement device, a horizontal rotational movement device and a vertical linear movement device.

The horizontal rotational movement device rotates the storage module during when the horizontal linear movement device moves the storage module.

The storage module comprises one or more sub-compartments and one or more access doors for the sub-compartments. Alternatively, the storage module comprises a compartment and an access door for the compartment.

The transportation device further comprises a grabbing device that positions the storage module on the transportation device.

The storage structure further comprises one or more queuing bays that into which retrieved storage modules are positioned for access by a user.

The control device authenticates a user to allow access to the user's compartment or sub-compartment; controls the transportation device to retrieve the storage module that includes the user's compartment or sub-compartment from the storage spaces that stores the storage module, to transport the storage module from the storage space to the queuing bay at which that the user waits the user's compartment or sub-compartment, to open the access door for the user's compartment or sub-compartment; waits predetermined time to allow the user to load or unload; controls the storage module to close the access door, to transport the storage module from the queuing bay to a designated space for the user and to store the storage module in the designated space.

The control device controls the horizontal rotational movement device to rotate the storage module during when the horizontal linear movement device moves the storage module so that the user's compartment or sub-compartment is aligned in a predetermined direction in the queuing bay.

The queuing bay comprises a safety sensor that checks existence of person or animal inside the storage module.

The advantageous effects of the present invention are: (1) the self storage system allows users to store their personal items in a movable storage container with the capacity of maximum weight allowance up to 5500 lbs including the weight of a storage container; (2) only predetermined (pre authorized) users have access to individual containers in the rack and rail steel super structure storage facility; (3) the storage containers are transported on user's command via lift system and shuttle/turntable system into the queuing bay (access bay) for efficient, convenient and easy storage and retrieval of goods to and from the storage facility and the vehicle; (4) the automated self storage facility eliminates the need of the access corridors thus utilizing most of the storage facility footprint for storage purposes; (5) the automated self storage could be built up to maximum height limit of the allowable building envelope of the land use zoning, thus maximizing the efficiency of the storage facility.

### BRIEF DESCRIPTION OF THE DRAWINGS

The accompanying drawings illustrate the best embodiments of the present invention. In the drawings:

FIG. 1 is a schematic plan view that shows layout of the overall storage facility;

FIG. 2 is a schematic elevation view of the storage facility;

FIGS. 3(a)-3(e) are schematic views showing options of different configuration of compartmentalized storage containers;

FIG. 4 is a schematic perspective view showing queuing bays;

FIG. 5 is a schematic perspective view showing sensors in the queuing bay;

FIG. 6 is a flow diagram showing the operational logic sequence of the automated self storage system; and

FIG. 7 is a schematic diagram showing a fully automated autonomous self storage system according to the present invention.

### DESCRIPTION OF PREFERRED EMBODIMENTS

Embodiments will be described in detail below. The accompanying drawings will be used for describing embodiments. For the sake of convenience of illustrating embodiments, thickness, length, diameter, size and other dimensions of components would be illustrated or exaggerated to be different with those of actual components, and the subject matter of this application is not limited to the illustrated embodiments.

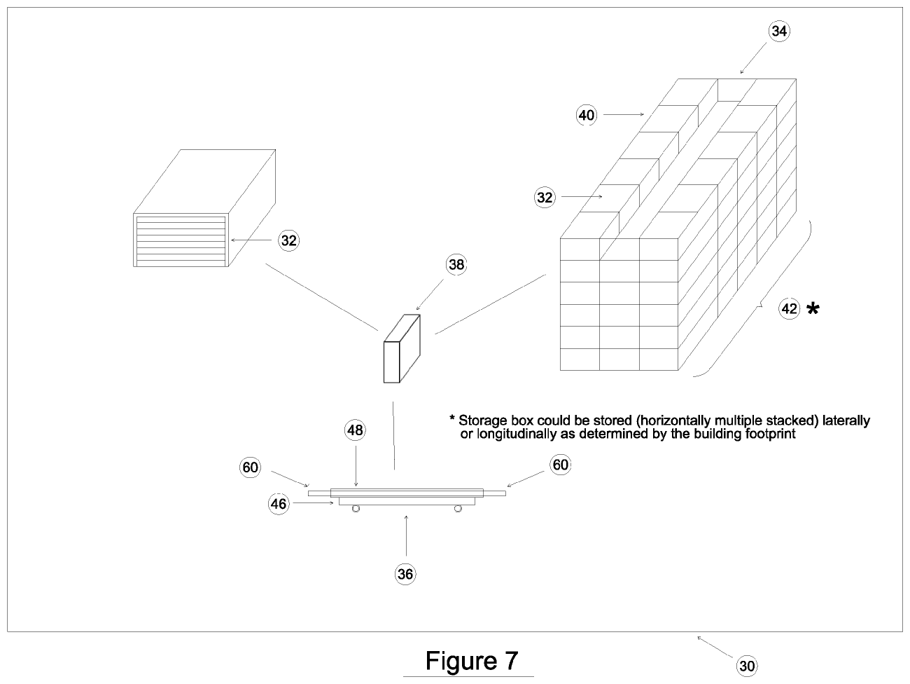

Referring to FIG. 7, the present invention provides a storage system 30 comprising a plurality of storage modules 32, which are stored in a three-dimensional array 34; one or more transportation devices 36 that transport the storage modules 32; a control device 38 that controls movements of and access to the storage modules 32; and a storage structure 40 that comprises storage spaces 42 for storing the storage modules 32, and transportation tracks 44 for the transportation devices 36. The storage spaces 42 comprise the three-dimensional array 34. The transportation device 36 comprises a horizontal linear movement device 46, a horizontal rotational movement device 48 and a vertical linear movement device 50.

The horizontal rotational movement device 48 rotates the storage module 32 during when the horizontal linear movement device 46 moves the storage module 32.

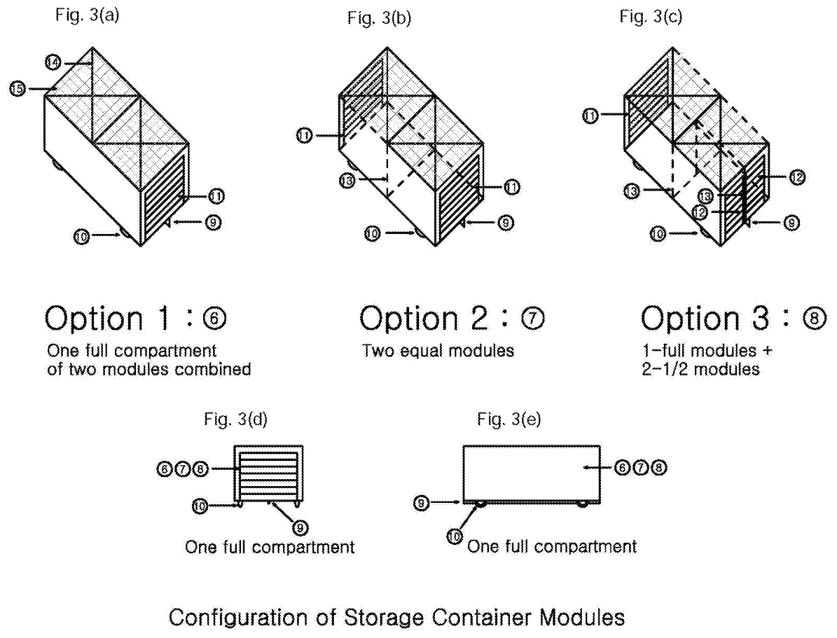

Referring to FIGS. 3a-3e, the storage module 32 comprises one or more sub-compartments 52 and one or more access doors 54 for the sub-compartments 52. Alternatively, the storage module comprises a compartment 56 and an access door 58 for the compartment 56.

The transportation device 36 further comprises a grabbing device 60 that positions the storage module 32 on the transportation device 36.

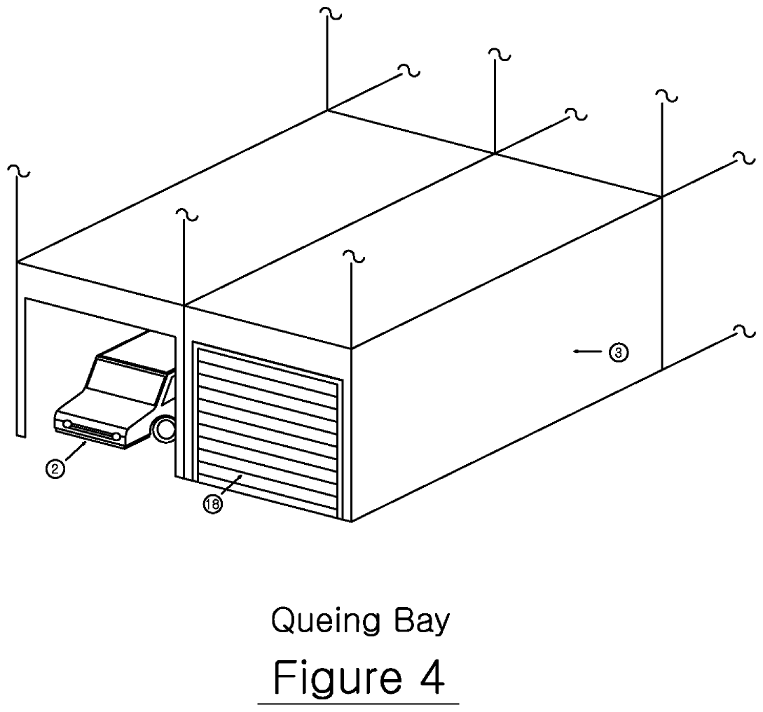

Referring to FIG. 4, the storage structure 40 further comprises one or more queuing bays 3 that into which retrieved storage modules 32 are positioned for access by a user.

The control device 38 authenticates a user to allow access to the user's compartment 56 or sub-compartment 52; controls the transportation device 36 to retrieve the storage module 32 that includes the user's compartment 56 or sub-compartment 52 from the storage spaces 42 that stores the storage module 32, to transport the storage module 32 from the storage space 42 to the queuing bay 3 at which that the user waits the user's compartment 56 or sub-compartment 52, to open the access door 54, 58 for the user's compartment 56 or sub-compartment 52; waits predetermined time to allow the user to load or unload; controls the storage module 32 to close the access door 54, 58, to transport the storage module 32 from the queuing bay 3 to a designated storage space 42 for the user and to store the storage module 32 in the designated space 42. With the rack and rail structure of the storage system 30, the storage module 32 is transported along predetermined tracks and stored at predesignated storage space. The storage module comprises a standardized space for receiving the standardized compartment and sub-compartment. The transportation device only transports the load on it, that is, the storage module. The rack and rail structure requires only beams and rails and does not require floor, wall or ceiling. Considerations for human users are required only for queuing bays. The inside operation of the storage system are autonomously controlled and fully mechanized.

The control device 38 controls the horizontal rotational movement device 48 to rotate the storage module 32 during when the horizontal linear movement device 46 moves the storage module 32 so that the user's compartment 56 or sub-compartment 52 is aligned in a predetermined direction in the queuing bay 3.

The queuing bay 3 comprises a safety sensor 62 that checks existence of person or animal inside the storage module 32.

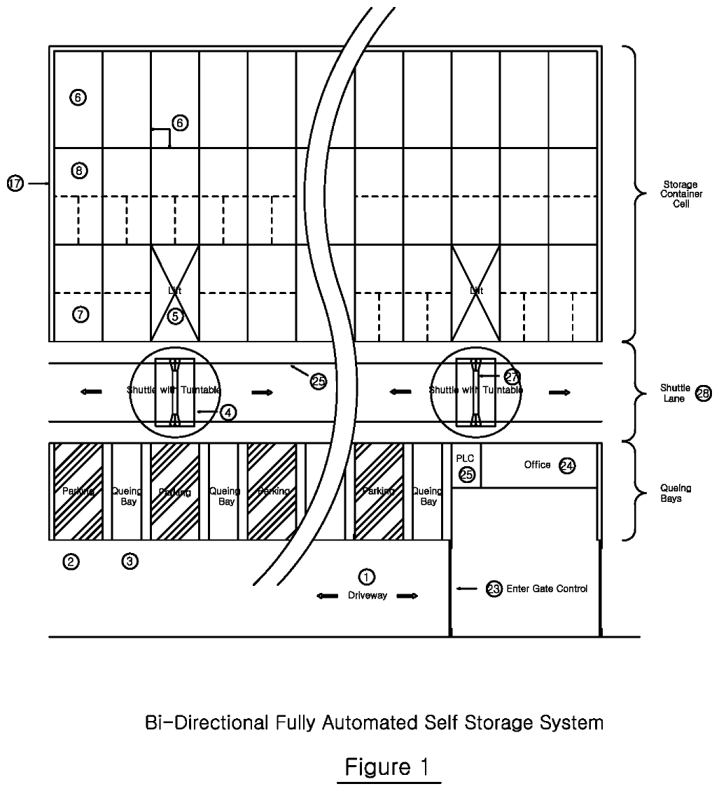

Referring to FIG. 1, This invention combines the vertical component (lift elevator 5, which is the vertical linear movement device 50), horizontal component (bi-directional lateral movement shuttle 4, which is the horizontal linear movement device 46), effective container retrieval grabber mechanism, which is the grabbing device 60, rotational capabilities while shuttle is in horizontal motion for time efficiency purposes, which is the function of the horizontal rotational movement device 48, and potentially equal number of queuing bays 3 that matches to the number of storage columns which allows the maximum number of accessible interface at the queuing bays for user efficiency and convenience.

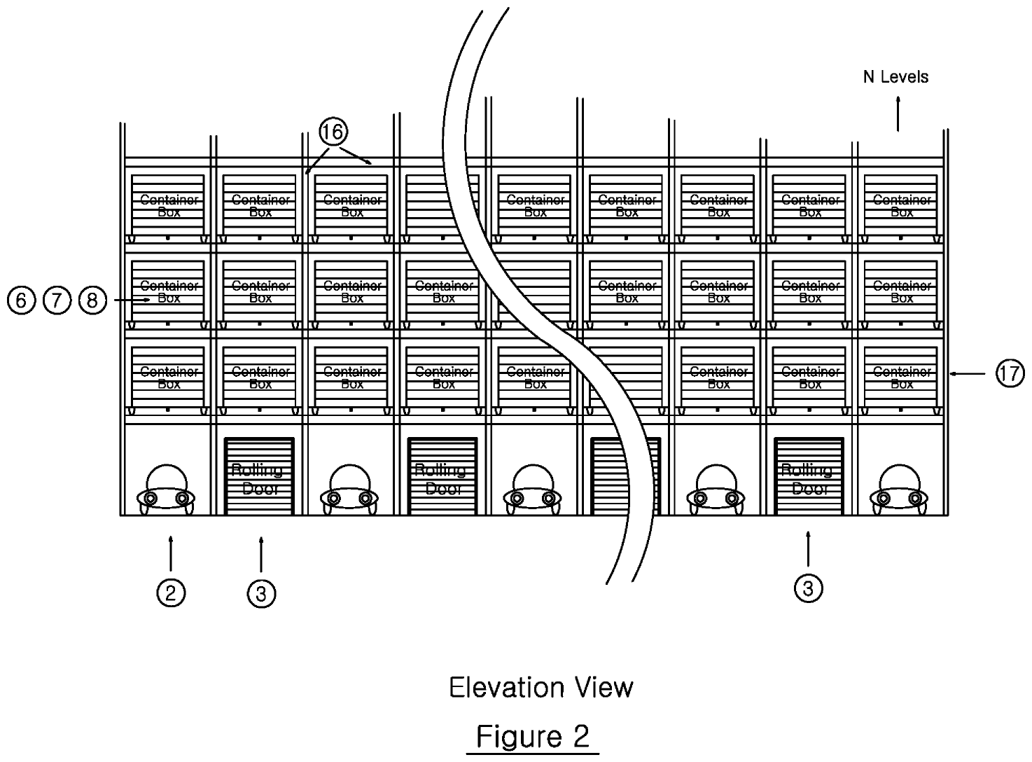

Referring to FIGS. 1 and 2, the fully automated self storage (the storage system 30) with rack and rail system facility (three dimensional array 34, transportation track 44), which stores n number of storage containers (storage module 32) throughout the storage facility, could be accessed by limited predetermined (registered) users of approved status. The preassigned storage container is transported with the fully automated Programmable Logic Control (PLC) command system 25 (the control device 38), shuttle and turntable system, and lift system from the queuing bay 3 (access location) to a predesignated cell 2 (storage space 42) inside the rack and rail steel super structure 16 (storage structure 40) with efficiency and convenience, to provide storage and retrieval of goods on demand triggered by the manual keypad entry or with the keycard (or keyfob) issued to a registered user. The orientation of storage container is programmed to rotate on a turntable during lateral movement of the shuttle to position the door for easy user access during the retrieval sequence. At the conclusion of storage container access, system could be activated by the keycard to return the container to its original cell location or return to randomly available cell location (PLC could be programmed to management's preference based on the system efficiency). The PLC system 25 which is the central command module keeps track of the location of the storage container 6, 7, 8 and its predetermined user information.

Referring to FIGS. 3(a)-3(e), the storage container (storage module 32) is uniform in its overall dimension and is further compartmented to provide several options of smaller storage spaces. Ratio of container size options is customized to fit the need of each storage facility. These storage containers are transported to the accessing (queuing) bay 3 on ground level for easy access for users to remove/store their goods.

The fully automated self storage system 30 consists of six main components:
1. Main Control System (control device 38)
2. Queing (Accessible) Bays 3
3. Lift System (vertical linear movement device 50)
4. Shuttle/Turntable System with a container grabbing arm mechanism (horizontal linear movement device 46, horizontal rotational movement device 48, grabbing device 60)
5. Storage Containers (storage module 32)
6. Steel Rack and Rail System (three dimensional array 34, transportation track 44)

The fully automated self storage system 30 takes the storage container 32 from the queuing bay 3 after the container 32 is filled with user's goods with the lateral moving ground level shuttle 46, 48 equipped with retrieval arms mechanism (grabber 60) to transfer the container onto the shuttle and then laterally transports the container to the vertical lift/elevator 50 to take the storage container 32 to a designated level, moving shuttle carts that take the containers from lift and transports them laterally on each level, and stalls 2 on each level where the containers are stored (number of containers on each level is determined by the size and configuration of the lot and the building design).

Every fully automated self storage system 30 is controlled by a customized software application (PLC, Programmable Logic Control 25) incorporated into the system. The time necessary to enter the system whether or not there will be any staging (queing) areas and the time necessary to retrieve a container are dependent on how you choose to customize your system. The mechanical aspects themselves are relatively static. In other words, the time it takes once the container is in the queing bay to when it is placed in a final stored cell space is predetermined. The system could be pre-programmed to assign spaces for prequalified users, or, it could have all spaces available on a first come first serve basis selected randomly by the system. The registered users will be issued a cardkey or a keyfob to allow immediate system access upon arrival in the parking space made available in front or next to the queing bay.

Accessibility to the automated self storage system is explained:
1. Limited number of users will have access to the automated self storage system 30.
2. User registers at the management office 24 to be an authorized user of the system 30.
3. User will be given a card key or a key fob to access the system 30.
4. Ingress and egress is preferred off of an alley (where alley is not available, then driveway according to LADBS codes) with minimum of 20′-30′ approach in front of the queuing bay 3 or approach into the parking space next to the queuing bay.
5. There will be lights above each queuing bay door location that will illuminate red when that particular bay is in use, and green when it is immediately available.
6. User can also manually enter the access code assigned to each individual at the queuing bay.
7. User parks his/her vehicle in the designated parking space and accesses the available queuing bay 3 (with the green light). A high speed door 18 of the queuing bay will open when the pre designated (at the time of registration) storage container 32 arrives in the queuing bay 3.
8. The storage container has its own rollup door 11, 12 and a provision for lock hasp to put user's own lock for additional security (highly recommended).
9. User can transfer their goods into the storage container 32.
10. The system will be programmed to allow users specified time (usually 30 min-1 hour) to access the storage container 32.
11. When the specified time is up, the system will ask user if he or she needs more time to complete their activities.
12. At the conclusion of goods transfer, walk over to a monitor screen to answer 4 exit questions in random order to avoid answering the same pattern:
   a. Do you have all your personal items out of the container? Yes or No
   b. Is there anyone inside the container including any pets? Yes or No
   c. Are your container doors securely closed and locked? Yes or No
   d. Do you agree that you have double checked all these questions and answered them properly? Yes or No
13. The container will be weighed inside the queuing bay for weight qualification. If the weight of container exceeds the maximum limit (set at 5500 lbs), system will not be activated until the over weight limit is resolved and cleared.
14. Laser sensors in the queuing bay will monitor any inferences of the container doors to verify it is securely closed. Queuing rollup door will not close if the sensor detects any interferences.
15. Upon exit from the load bay, scanning sensors such as IR sensors 19 and motion sensors 20 (optional video sensor) will be activated to confirm that no animals or persons are in the queuing bay and inside the container when the exit door closes and locks. Only then will the system be activated and take the storage container to a designated cell in the system.

Retrieval of the self storage container is explained:
1. As proposed, when the user wants to retrieve his or her storage container 32, there will be a card reader, keyfob reader, or a manual keypad entry system at the outer door of the queuing bay 3.
User identifies the available queuing bay 3 by locating a green light above the available queuing bay and parks his/her vehicle into the parking space next to the bay.
2. The individual merely needs to place his or her key fob/keycard on the card reader or enter the access code manually at the keypad. The system then is automatically activated and the storage container 32 is retrieved.
3. The storage container arrives in the queuing bay (rotated if necessary) to have the access door 11, 12 of the storage container facing out towards user. Light above the bay door is red during retrieval operation.
4. The red light above the queuing bay turns to green light and the queuing bay rollup door opens.
5. Repeat steps 8 through 14 in Section of the Automated Self Storage System Accessibility.

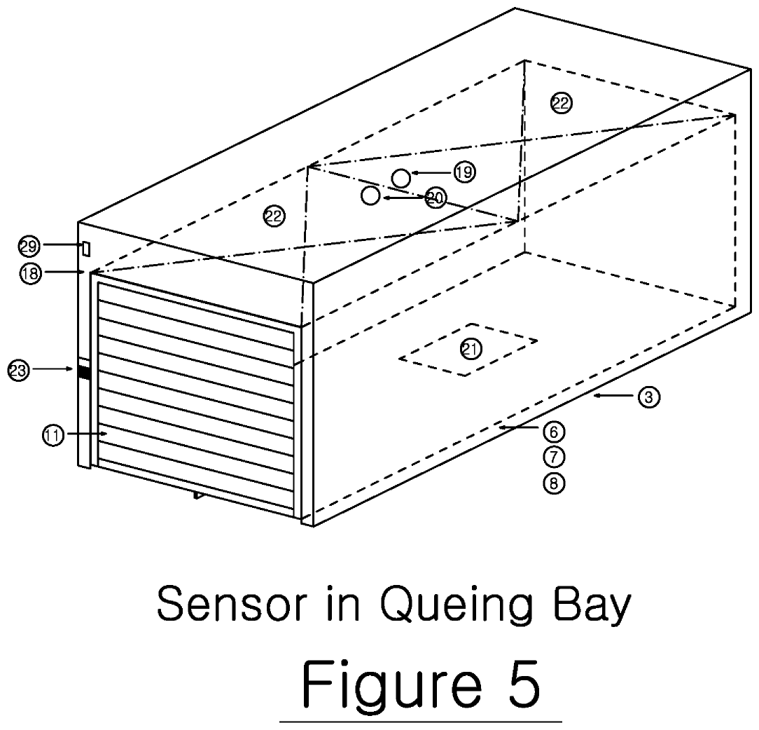

System features are explained:
1. System comprises of lift, shuttle, turntable, PLC controls, laser sensors, safety sensors, storage containers, steel structures and rails.
2. Infrared, laser, and motion sensors are installed in the queuing bay to detect the presence of live animals or persons prior to system operation (FIG. 5).
3. Laser sensors and weight sensor are present in the queuing bay to verify/qualify the weight and make sure the container doors are securely closed (FIG. 5).
4. Once the storage container is positioned on the ground shuttle, lift mechanism is guided by laser position sensor to take the container to a designated level.
5. The storage container is then transferred onto the cableless shuttle (or moving cart) on each respective level to laterally transport the container to its designated cell with a laser guidance.
6. Emergency generator is provided for operation of the storage system during the power outage.

Detailed system sequences are explained. FIG. 1 illustrates the plan view layout of the overall storage facility 17 and ingress/egress driveway 1 with the management office 24 and equipment control room 25 at the front of the storage facility 17 where user vehicle passes through the entry gate 23, then approaches the pre-designated queuing bay 3 and parks his/her vehicle 2 to access the queuing bay 3. Storage steel racks 16, ground shuttle lane 28, vertical lift 5, lateral moving ground shuttle with turntable 4, shuttle rails 26 and containers 6, 7, 8 are situated in the rear of the queuing bays 3.

FIG. 2 illustrates elevated (sectional) view of the storage facility 17 with the front view of parking area 2, queuing bays 3 with a quick action rollup doors 18, storage containers 6,7,8, and steel rack structure 16. n levels indicate the height of storage facility could vary with the area land use zoning requirements which will determine the maximum storage levels. Each level is equipped with later movement shuttle with turntable 4, shuttle rails 26 and shuttle lane 28.

FIGS. 3(a)-3(e) illustrate three options of different configuration of compartmentalized storage containers. These containers 6, 7, 8 have overall box dimension with a steel braced 14 open top and a mesh cover 15. The containers have roller wheels 10 to ride on the steel rail track 26. At the bottom of the container has the vertical rib 9 for the grabber arm mechanism 27 on a shuttle 4 to grab and transfer the container onto the shuttle. Option (1) 6 is the largest whole container with rollup doors 11 at each end (FIG. 3(a)). Option (2) 7 is divided into two equal compartments with a divider wall 13 and rollup doors 11 (FIG. 3(b)). Option (3) 8 provides a quarter size compartments with divider walls 13 and smaller size rollup doors 12 (FIG. 3(c)).

FIG. 4 illustrates a blown up isometric diagram of queuing bay 3 with the parking space 2 next to it and the main queuing bay rollup door 18.

FIG. 5 illustrates safety sensors and other features inside the queuing bay 3 with the queuing bay rollup door 18 in open position. To the left of the queuing bay is the keypad entry control 23 and mounted on ceiling of the queuing bay has both heat sensor 19 and movement (video) sensor 20 with lighting fixtures 22. When the storage container enters the queuing bay, it will be sitting on the weight scale 21 to monitor the gross weight of the storage container 6, 7, 8. Laser sensor is used to monitor interferences at the rollup door 29.

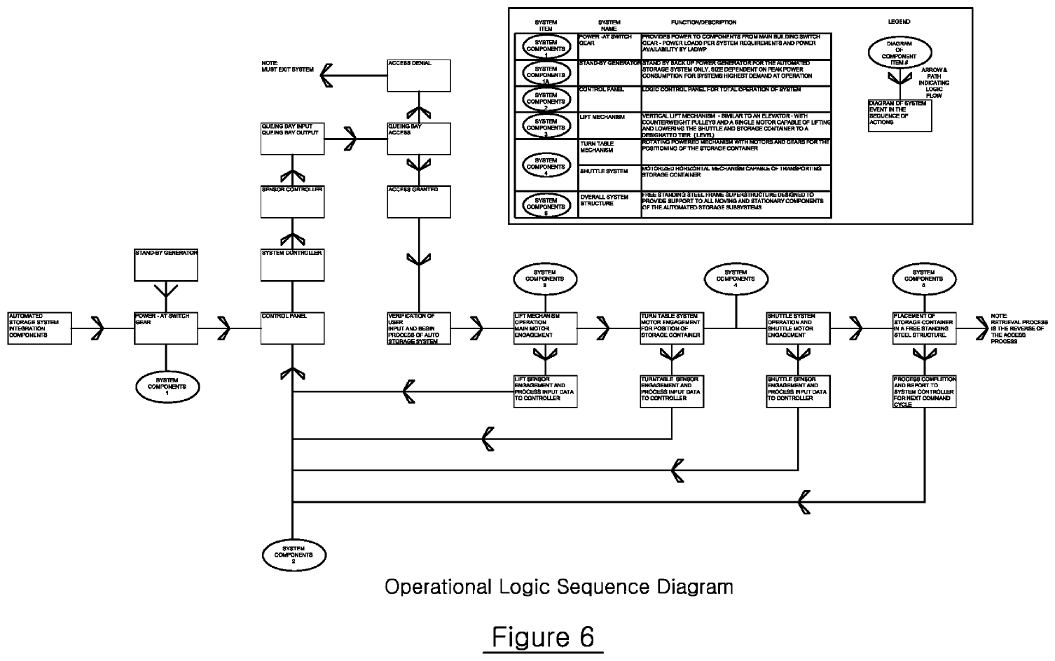

FIG. 6 illustrates the operational logic sequence of the automated self storage system divided into five large blocks of system components.

The following table illustrates the list of itemized components in the FIGS. 1 thru 7.

TABLE OF LISTED ITEMS

1. Vehicle Driveway Approach (alley Or driveway)
2. Vehicle Parking Stall
3. Queuing Bay (Storage Container Accessing Bay)
4. Lateral Movement Shuttle with Turntable and Grabber Arm
Mechanism
5. Vertical Lift (Elevator) to transport containers to each level
6. Large Size Storage Container - Full Size
7. Medium Size Storage Container - Half Size
8. Small Size Storage Container - Quarter Size
9. Vertical Rib that runs underneath the container (@ center)
along the long side to allow Shuttle Grabber Arm to pull the
container
10. Container Roller wheels
11. Container Access Rollup Door for Large and Medium Sized
Containers
12. Container Access Rollup Door for Small Sized Containers
13. Container Compartment Divider Wall
14. Container Open Top Bracing
15. Container Open Top Heavy Gauge Steel Mesh Cover
16. Storage Facility Steel Structure Members - Super structure
17. Storage Facility Perimeter Walls
18. Queuing Bay Rollup Door
19. Queuing Bay Ceiling Mounted Heat Sensor
20. Queuing Bay Ceiling Mounted Motion Sensor (optional: video
sensor)
21. Weight Scale
22. LED Lighting Fixture
23. Queuing Bay Keypad Entry Control
24. Storage Facility Management Office
25. Fully Automated Storage Control Panel (Programmable Logic
Control) and Power Supply Room
26. Shuttle Rails
27. Shuttle Grabber Arm Mechanism
28. Shuttle Lane
29. Queuing Bay Rollup Door Interference Laser Sensor
30. Storage system
32. Storage module
34. Three dimensional array
36. Transportation device
38. Control device
40. Storage structure
42. Storage space
44. Transportation track
46. Horizontal linear movement device
48. Horizontal rotational movement device
50. Vertical linear movement device
52. Sub-compartment
54. Access door
56. Compartment
58. Access door
60. Grabbing device
62. Safety Sensor

The present invention also provides a one stop solution that combines fully automated parking stalls (patent application Ser. No. 15/655,862) and a fully automated carwash (patent application Ser. No. 15/713,528) and the fully automated storage, which was explained above. Parking stalls vs. self storage spaces ratio is flexible in accordance with market conditions to create tailored system for attaining the optimum revenue. This combined system uses autonomous robotic system utilizing the pallet system and pallet transfer mechanism to move the pallet in and out of the car wash room, the queuing bay for storage access or to park a car. Serviced vehicles (washed cars), storage compartments or cars to be parked can be retrieved at the entry recognition control panel and exit from the load bays same way as the normal retrieval of parked cars from the autonomous parking system.

Although the automated parking structure with integrated car wash system according to an exemplary embodiment of the present invention has been described in detail herein above, it should be understood that many variations and modifications of the basic inventive concept herein described, which may appear to those skilled in the art, will still fall within the spirit and scope of the exemplary embodiments of the present invention as defined by the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A storage system comprising:
a) a plurality of storage modules, which are stored in a three-dimensional array;
b) one or more transportation devices that transport the storage modules;
c) a control device that controls movements of and access to the storage modules; and
d) a storage structure that comprises storage spaces for storing the storage modules, and transportation tracks for the transportation devices, wherein the storage spaces comprise the three-dimensional array;
wherein the transportation device comprises a horizontal linear movement device, a horizontal rotational movement device and a vertical linear movement device.

2. The storage system of claim 1, wherein the horizontal rotational movement device rotates the storage module during when the horizontal linear movement device moves the storage module.

3. The storage system of claim 2, wherein the storage module comprises one or more sub-compartments and one or more access doors for the sub-compartments.

4. The storage system of claim 2, wherein the storage module comprises a compartment and an access door for the compartment.

5. The storage system of claim 3, wherein the transportation device further comprises a grabbing device that positions the storage module on the transportation device.

6. The storage system of claim 5, wherein the storage structure further comprises one or more queuing bays that into which retrieved storage modules are positioned for access by a user.

7. The storage system of claim 6, wherein the control device authenticates a user to allow access to the user's compartment or sub-compartment; controls the transportation device to retrieve the storage module that includes the user's compartment or sub-compartment from the storage spaces that stores the storage module, to transport the storage module from the storage space to the queuing bay at which that the user waits the user's compartment or sub-compartment, to transport the storage module from the queuing bay to a designated space for the user and to store the storage module in the designated space.

8. The storage system of claim 7, wherein the control device controls the horizontal rotational movement device to rotate the storage module during when the horizontal linear movement device moves the storage module so that the user's compartment or sub-compartment is aligned in a predetermined direction in the queuing bay.

9. The storage system of claim 8, wherein the queuing bay comprises a safety sensor that checks existence of person or animal inside the storage module.

10. The storage system of claim 7, wherein the control device controls the storage module to open the access door for the user's compartment or sub-compartment; waits predetermined time to allow the user to load or unload; controls the storage module to close the access door.
